(19) United States
(12) Patent Application Publication
(10) Pub. No.: US 2025/0391624 A1
(43) Pub. Date: Dec. 25, 2025

(54) ARCING EXHAUST GAS REMOVAL FOR CIRCUIT BREAKERS

(71) Applicant: EATON INTELLIGENT POWER LIMITED, DUBLIN 4 (IE)

(72) Inventors: Venkat raman Thenkarai Narayanan, Prague (CZ); Sandy Omar Jimenez Gonzalez, Coraopolis, PA (US); Rajesh Kumar Reddy Appal, Oakdale, PA (US); Laura Teresa Portuondo Bautista, Santo Domingo (DO)

(73) Assignee: EATON INTELLIGENT POWER LIMITED, DUBLIN 4 (IE)

(21) Appl. No.: 18/748,573

(22) Filed: Jun. 20, 2024

(51) Int. Cl. H01H 71/02

(52) U.S. Cl. CPC H01H 71/0235; H01H 2213/00

(57) ABSTRACT

A pole assembly housing for a miniature circuit breaker is structured to lessen pressure and temperature increases within the housing increase due to arcing gas. The housing includes an exhaust compartment, which includes an arc chamber where the separable contacts of the circuit breaker are located and an exhaust channel with a first end and a second end. The channel's first end is in fluid communication with the arc chamber and the second end is a vent opening in fluid communication with the environment external to the housing. The channel has a diverging shape such that the first end is the narrowest portion, and the channel widens between the first end and the vent opening. Multiple ribs are formed on the sidewall in the arcing chamber, and more ribs are formed on the walls surrounding the exhaust channel cool arcing gas and reduce pressure of the arcing gas.

### FIELD OF THE INVENTION

The disclosed concept relates generally to circuit breakers, and in particular, to devices and systems for mitigating the effects of arcing within circuit breakers.

### BACKGROUND OF THE INVENTION

Circuit interrupters, such as for example and without limitation, circuit breakers, are typically used to protect electrical circuitry from damage due to an overcurrent condition, such as an overload condition, a short circuit, or another fault condition, such as an arc fault or a ground fault. Circuit interrupters typically include mechanically operated separable electrical contacts, which operate as a switch. When the separable contacts are in contact with one another in a closed state, current is able to flow through any circuits connected to the circuit interrupter. When the separable contacts are separated from one another in an open state, current is prevented from flowing through any circuits connected to the circuit interrupter. The separable contacts may be operated either manually by way of an operator handle, remotely by way of an electrical signal, or automatically in response to a detected fault condition. Typically, such circuit interrupters include an actuator designed to rapidly close or open the separable contacts, and a trip mechanism, such as a trip unit, which senses a number of fault conditions to trip the separable contacts open automatically using the actuator. Upon sensing a fault condition, the trip unit trips the actuator to move the separable contacts to their open position.

Typically, when a circuit interrupter opens its separable contacts during a fault condition, an arc is generated across the contacts. The circuit interrupter is only considered fully open when the arc is completely extinguished. Arcing produces significant heat, which in turn can significantly increase the pressure within the circuit interrupter, and this heat and pressure can cause irreversible damage if the arc is not extinguished as quickly as possible. In miniature circuit breakers in particular, the arc that is generated under high fault currents can create high pressures and let-through energy that can lead to destruction or degradation of the circuit breaker case and current-carrying components, making it difficult to fulfill an ongoing desire to produce circuit breaker cases from more sustainable thermoplastics.

There is thus room for improvement in arc mitigation devices and systems in circuit breakers, including miniature circuit breakers.

### SUMMARY OF THE INVENTION

These needs, and others, are met by embodiments of an advantageously designed pole assembly housing for a circuit breaker. The pole assembly housing includes an arc chamber where the separable contacts of the circuit breaker are located, an exhaust channel that includes a diverging portion and is in fluid communication with the arc chamber, and a vent in fluid communication with the exhaust channel. Multiple ribs are formed within the arcing chamber leading toward the channel, and more ribs are formed on the walls surrounding the exhaust channel.

In one exemplary embodiment of the disclosed concept, a pole housing is structured to house a pole assembly of a circuit breaker and comprises: a main compartment formed within the interior of the pole housing; an exhaust compartment formed within the interior of the pole housing; a partition; a first wall that is a top wall disposed at the top of the pole housing when the pole housing is positioned in a first orientation; and a second wall that is adjacent to the first wall and is a side wall disposed at the side of the housing when the pole housing is positioned in the first orientation. The exhaust compartment comprises an arc chamber structured to house separable contacts of the circuit breaker and an exhaust channel. The exhaust channel comprises a first end and a second end, with the first end being a throat in fluid communication with the arc chamber, and the second end being a vent opening that is in fluid communication with the environment external to the pole housing. The partition is structured to partially separate the main compartment and the exhaust compartment. The cross-sectional area of the exhaust channel is smallest at the throat. The exhaust channel further comprises a mouth between the throat and the vent opening, a diverging portion disposed between the throat and the mouth, and a venting portion between the mouth and the vent opening. The cross-sectional area of the exhaust channel is greater at the mouth than at the throat. A central axis of the exhaust channel comprises a first line segment in the diverging portion and comprises a second line segment in the venting portion, the second line segment being disposed at an angle to the first line segment. The vent opening is an opening formed in the second wall, and when the pole housing is disposed in the first orientation, the vent opening is disposed laterally relative to the arc chamber. The exhaust compartment comprises a plurality of ribs, with each rib being a protrusion extending from a planar surface into the interior of the exhaust compartment.

In another exemplary embodiment of the disclosed concept, a circuit breaker comprises: a breaker enclosure, a semiconductor device, a stationary conductor comprising a stationary contact, a movable conductor comprising a movable contact, and a pole housing. The movable conductor is structured to be actuated between a closed state and an open state, with the movable contact being in electrical contact with the stationary contact in the closed state and being electrically isolated from the stationary contact in the open state. The pole housing comprises: a main compartment formed within the interior of the pole housing; an exhaust compartment formed within the interior of the pole housing; a partition; a first wall that is a top wall disposed at the top of the pole housing when the breaker enclosure is positioned in a first orientation; and a second wall that is adjacent to the first wall and is a side wall disposed at the side of the housing when the breaker enclosure is positioned in the first orientation. The breaker enclosure houses the pole housing and the semiconductor device, and when the breaker enclosure is positioned in the first orientation, the semiconductor device is disposed above the pole housing. The exhaust compartment comprises an arc chamber structured to house the stationary and movable separable contacts and an exhaust channel. The exhaust channel comprises a first end and a second end, with the first end being a throat in fluid communication with the arc chamber, and the second end being a vent opening that is in fluid communication with the environment external to the pole housing. The partition is structured to partially separate the main compartment and the exhaust compartment. The cross-sectional area of the exhaust channel is smallest at the throat. The exhaust channel further comprises a mouth between the throat and the vent opening, a diverging portion disposed between the throat and the mouth, and a venting portion between the mouth and the vent opening. The cross-sectional area of the exhaust channel is greater at the mouth than at the throat. A central axis of the exhaust channel comprises a first line segment in the diverging portion and comprises a second line segment in the venting portion, the second line segment being disposed at an angle to the first line segment. The vent opening is an opening formed in the second wall, and when the breaker enclosure is disposed in the first orientation, the vent opening is disposed laterally relative to the arc chamber. The exhaust compartment comprises a plurality of ribs, with each rib being a protrusion extending from a planar surface into the interior of the exhaust compartment.

### BRIEF DESCRIPTION OF THE DRAWINGS

A full understanding of the invention can be gained from the following description of the preferred embodiments when read in conjunction with the accompanying drawings in which:

FIG. 1 is a sectional view of a pole assembly of a prior art circuit breaker;

FIG. 2 is a sectional view of a pole assembly of an improved circuit breaker, in accordance with an example embodiment of the disclosed concept;

FIG. 3 is an enlarged view of a portion of FIG. 2;

FIG. 4 is a perspective view of the pole assembly shown in FIG. 2, with an optional arc plate included; and

FIG. 5 is a sectional view of a pole assembly of another improved circuit breaker, in accordance with another example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

Described herein are embodiments of an improved circuit breaker 101 whose exhaust structure is advantageously designed to more efficiently exhaust gas produced by arcing (referred to hereafter as “arcing gas”), relative to a prior art circuit breaker 1. As an initial matter, it is noted that a height dimension 501 and a width dimension 502 are marked in the figures for ease of explanation, with the height and width dimensions 501,502 being orthogonal to one another. The terms “height” and “width” are used solely to denote the orientation of these dimensions relative to the views shown in the figures and are not intended to signify that the detailed description provided herein applies only when the illustrated circuit breakers are positioned in the orientations shown in the figures. In addition, a direction/orientation 511 coinciding with the height dimension and a direction/orientation 512 coinciding with the width dimension 502 are marked in the figures, and the directions 511 and 512 should be understood to be orthogonal to one another. The directions 511 and 512 are used to describe movement or orientation of various components relative to one another, as will become apparent herein. In particular, the reference number 512 is used herein to denote that one component is positioned “laterally” relative to another component.

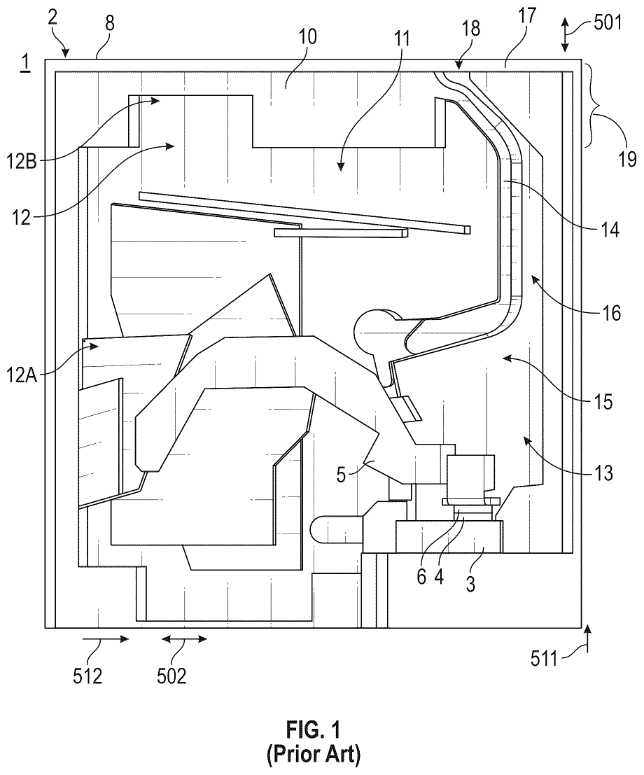

FIG. 1 is a sectional view of a single pole assembly 2 of the prior art circuit breaker 1, the circuit breaker 1 being a miniature circuit breaker. The pole assembly 2 comprises a stationary conductor 3 with a stationary contact 4 and a movable conductor 5 with a movable contact 6. The stationary conductor 3 is structured to be connected to a power source (not pictured) and the movable conductor 5 is structured to be connected to a load (not pictured). The movable conductor 5 is structured to be actuated between a closed state and an open state. In the closed state, which is shown in FIG. 1, the movable contact 6 is in physical contact with and electrically connected to the stationary contact 4. In the open state, the movable contact 6 is physically separated and electrically isolated from the stationary contact 4.

When the movable conductor 5 is in the closed state, the load can receive power from the power source via the stationary and movable conductors 3,5. When the movable conductor 5 is actuated from the closed state shown in FIG. 1 to the open state (referred to as “opening” of the movable conductor 5 or an “opening operation”), the movable contact 6 moves away from the stationary contact 4 in the direction 511. When the movable conductor 5 is opened under a fault condition (e.g. an overcurrent condition), arcing occurs as a result of the separable contacts 4,6 separating, and arcing gas is produced.

The circuit breaker 1 comprises a breaker enclosure 8 (depicted schematically in FIG. 1) and a pole housing 10 for each pole assembly 2. The breaker enclosure 8 houses all of the pole housings 10. Each pole housing 10 comprises an interior compartment 11 formed within the interior of the pole housing 10 in order to house the components of the corresponding pole assembly 2 and separate the pole assembly 2 from every other pole assembly 2. The interior compartment 11 comprises a main compartment 12 and an exhaust compartment 13.

The main compartment 12 and the exhaust compartment 13 are partially separated by a partition 14 while also being in fluid communication with one another, i.e. such that arcing gas can pass between the main compartment 12 and the exhaust compartment 13. The majority of the movable conductor 5 is disposed within the main compartment 12, although the movable conductor 5 extends in the direction 512 from the main compartment 12 to the exhaust compartment 13 such that a portion of the movable conductor 5 is positioned within the exhaust compartment 13. The stationary and movable contacts 4,6 are both disposed within the exhaust compartment 13.

The exhaust compartment 13 comprises an arc chamber 15 and an exhaust channel 16 in fluid communication with the arc chamber 15. Specifically, a first end of the exhaust channel 16 is in fluid communication with the arc chamber 15, and a second end of the exhaust channel 16 disposed opposite the first end is in fluid communication with the environment external to the pole housing 10 (such external environment being within the breaker enclosure 8). The second end of the exhaust channel 16 can be referred to as the exhaust vent opening 17. The exhaust vent opening 17 is an opening formed in a top wall 18 of the pole housing 10. When arcing occurs due to opening of the movable conductor 5, some of the arcing gas gets exhausted from the arc chamber 15 to the exterior of the pole housing 10 through the exhaust channel 16 and exhaust vent opening 17, and some of the arcing gas flows into the main compartment 12 as well.

Although not visible in detail in FIG. 1, the pole assembly 2 comprises an operating mechanism that actuates the movable conductor 5 from a closed state to an open state, and the operating mechanism includes a spring (not visible in FIG. 1). In the prior art circuit breaker 1, when arcing occurs due to opening of the movable conductor 5, the arcing gas significantly increases temperature and pressure within the exhaust compartment 13 and within the main compartment 12, such as in the regions 12A and 12B. The combination of high pressure and temperature resulting from the production of arcing gas, particularly around the region 12A, causes the operating mechanism spring to anneal and thus fail to properly function.

The design for the disclosed improved circuit breaker 101 arose out of a need to lessen the degree to which the temperature and pressure in the main compartment 12 increase due to arcing, in order to preserve the structural integrity of the mechanism spring and extend the life of the operating mechanism. In addition, the prior art circuit breaker 1 was designed prior to the implementation of certain electrical standards that now require a semiconductor interrupter device to be included in addition to mechanical separable contacts, in order to increase the speed and efficiency of a current interruption operation. Producing a circuit breaker that includes a semiconductor device and that maintains the same or a similar form factor as the breaker enclosure 8 of the prior art circuit breaker 1 necessitates reducing the size of the pole housing 10 of the prior art circuit breaker 1, so that a semiconductor device can be housed within a breaker enclosure along with the pole housing. As detailed further hereafter, the disclosed improved circuit breaker 101 fulfills these requirements and meets the updated electrical standards in ways that the prior art circuit breaker 1 cannot.

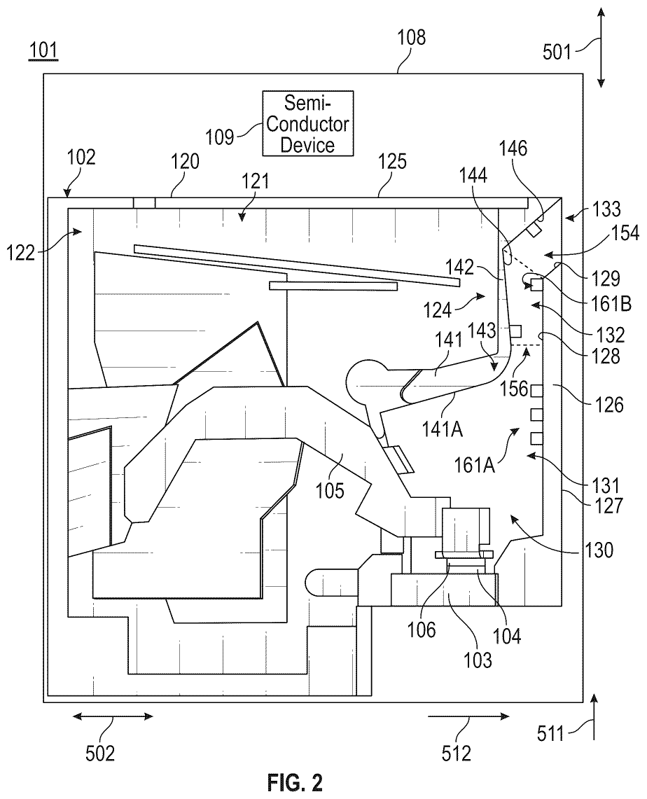

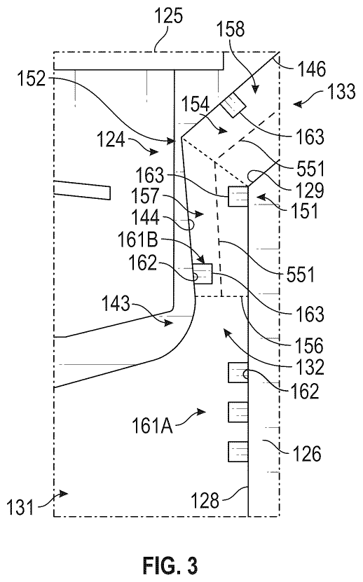

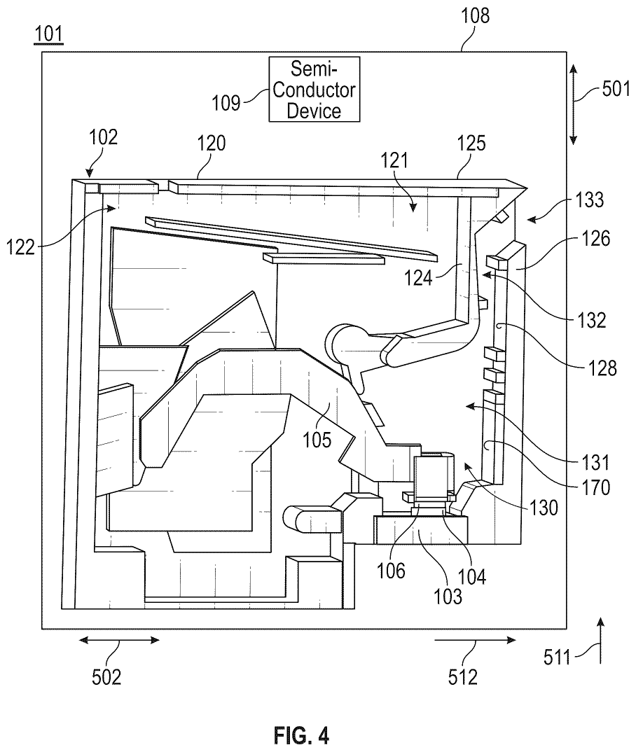

Reference is now made to FIG. 2, which is a sectional view of one pole assembly 102 of the disclosed improved circuit breaker 101, in accordance with an example embodiment of the disclosed concept. It should be understood that the circuit breaker 101 can include a number of pole assemblies 102. FIG. 3 is an enlarged view of a portion of FIG. 2. FIG. 4 is a partial perspective view of the same pole assembly 102 shown in FIG. 2, with an optional arc plate 170 included. For clarity and ease of illustration, some of the reference numbers used in FIG. 2 are omitted from FIG. 4.

The mechanical interrupter setup of the improved circuit breaker 101 is functionally equivalent to that of the prior art circuit breaker 1. That is, each pole assembly 102 of the improved circuit breaker 101 comprises a stationary conductor 103 with a stationary contact 104 and a movable conductor 105 with a movable contact 106, with the stationary conductor 103 being structured to electrical connect to a power source (not pictured) and the movable conductor 105 being structured to electrically connect to a load (not pictured). The stationary conductor 103 and movable conductor 105 function in the same manner as the stationary conductor 3 and movable conductor 5 of the prior art circuit breaker 1 to connect and disconnect a load from a power source. That is, the movable conductor 105 is structured to be actuated from the closed state shown in FIG. 2 to an open state. The movable contact 106 moves away from the stationary contact 104 in the direction 511 when the movable conductor 105 is opened from its closed state to its open state.

The improved circuit breaker 101 comprises a breaker enclosure 108 (depicted schematically in FIG. 2) and comprises an improved pole housing 120 for each pole assembly 102. The breaker enclosure 108 houses all pole housings 120 of the circuit breaker 101. The pole housing 120 comprises an interior compartment 121 formed within the interior of the pole housing 120 in order to house the components of the corresponding pole assembly 102 and separate the pole assembly 102 from every other pole assembly 102. The interior compartment 121 comprises a main compartment 122 and an exhaust compartment 130. The improved pole housing 120 shares some general similarities with the prior art pole housing 10, but the exhaust compartment 130 of the improved pole housing 120 includes several structural features that significantly lessen the degree to which temperature and pressure increase in the exhaust compartment 130 due to arcing, relative to the prior art exhaust compartment 13.

The pole housing 120 comprises a partition 124. The main compartment 122 and the exhaust compartment 130 are partially separated by the partition 124 while also being in fluid communication with one another, i.e. such that arcing gas can pass between the main compartment 122 and the exhaust compartment 130. The majority of the movable conductor 105 is disposed within the main compartment 122, although the movable conductor 105 extends in the direction 502 from the main compartment 122 to the exhaust compartment 130 such that a portion of the movable conductor 105 is positioned within the exhaust compartment 130. The stationary and movable contacts 104,106 are both disposed within the exhaust compartment 130.

The pole housing 120 also comprises a top wall 125 and a side wall 126. The top wall 125 faces the surface of the stationary contact 104 that engages the movable contact 106. The side wall 126 is disposed adjacent to the top wall 125 and forms an angle with the top wall 125 such that the side wall 126 is disposed entirely laterally 512 relative to the stationary contact 104. The partition 124 extends from the top wall 125 toward the stationary contact 104.

The exhaust compartment 130 comprises an arc chamber 131 and an exhaust channel 132 in fluid communication with the arc chamber 131. Specifically, a first end of the exhaust channel 132 is in fluid communication with the arc chamber 131, and a second end of the exhaust channel 132 disposed opposite the first end is in fluid communication with the environment external to the pole housing 120 (such external environment being within the breaker enclosure 108). The second end of the exhaust channel 132 can be referred to as the exhaust vent opening 133. The exhaust vent opening 133 is an opening formed in the side wall 126. When arcing occurs due to opening of the movable conductor 105, some of the arcing gas gets exhausted from the arc chamber 131 to the exterior of the pole housing 120 through the exhaust channel 132 and exhaust vent opening 133, while some of the arcing gas flows into the main compartment 122 as well.

The breaker enclosure 108 maintains a form factor similar to the prior art breaker enclosure 8, but the breaker enclosure 108 additionally houses a semiconductor device 109 (depicted schematically in the figures) that is not included in the prior art circuit breaker 1, due electrical standards having been updated subsequent to the production of the prior art circuit breaker 1. The breaker enclosure 108 is able to maintain a similar form factor to the prior art breaker enclosure 8 due to the improved pole housing 120 being reduced relative to the size of the prior art pole housing 10. In comparing FIG. 2 to FIG. 1, it can be seen that the prior art pole housing 10 includes a portion 19 (denoted by a bracket at the right side of the figure) that is not included in the disclosed improved pole housing 120, such that the improved pole housing 120 is shorter in the height dimension 501 than the prior art pole housing 10 by a distance denoted by the bracket 19 in FIG. 1. The improved pole housing 120 omits the portion 19 of the prior art housing 10 because the semiconductor device 109 of the improved circuit breaker 101 occupies the space inside the breaker enclosure 108 that corresponds to where the portion 19 of the prior art pole housing 10 is situated.

Relative to the orientation of the prior pole assembly 2 in FIG. 1, the portion 19 of the prior art pole housing 10 is disposed at the top end of the pole housing 10. Relative to the orientation of the improved pole assembly 102 in FIG. 2, the breaker enclosure 108 is structured such that the semiconductor device 109 of the improved circuit breaker 101 is situated above the top end of the improved pole housing 120. The positioning of the semiconductor device 109 above the improved pole housing 120 necessitates positioning the exhaust vent opening 133 differently in the improved pole housing 120 relative to where the prior art exhaust vent opening 17 is positioned in the prior art pole housing 10, as explained below.

The prior art exhaust vent opening 17 is an opening formed within the top wall 18 of the pole housing 10, and the entire surface area of the top wall 18 is disposed above the arc chamber 15, i.e. such that movement from the arc chamber 15 to the top wall 18 is in the upward direction 511. In contrast, the improved exhaust vent opening 133 is an opening formed within the side wall 126 of the improved pole housing 120, and the entire surface area of the side wall 126 is not disposed above the arc chamber 131. Rather, the entire surface area of the side wall 126 is disposed adjacent to and laterally 512 relative to the arc chamber 131, i.e. such that movement from the arc chamber 131 to the side wall 126 is in the direction 512. In addition, the exhaust vent opening 133 is disposed laterally 512 relative to the arc chamber 131. Positioning the exhaust vent opening 133 in the side wall 126 of the improved pole housing 120 rather than in the top wall 125 prevent arcing gas from being exhausted directly onto the semiconductor device 109.

In addition to the exhaust vent opening 133 being advantageously positioned to prevent opening damage to the semiconductor device 109, the exhaust compartment 130 is advantageously structured to lessen the degree to which arcing gas produced in the arc chamber 131 increases in temperature and pressure, as compared to the degree to which arcing gas produced in the prior art arc chamber 15 increases in temperature and pressure. The two primary advantageous features of the exhaust compartment 130 that differentiate it from the exhaust compartment 13 are the diverging nature of the cross-sectional area of the exhaust channel 132, and the formation of a number of ribs 161A and 161B within the arc chamber 131 and within the channel 132, detailed further hereafter. In reading the following detailed discussion of the advantageous features of the exhaust compartment 130, it is noted that most reference numbers are provided in FIG. 2, but some reference numbers may be included only in FIG. 3 for clarity and ease of illustration.

The exhaust channel 132 is referred to as having a diverging cross-sectional area because some portions of the channel 132 are wider than other portions of the channel 132. The partition 124 comprises a contact-facing arm 141 and a sidewall-facing arm 142 that are continuous with one another and meet one another so as to form an elbow 143. The surface of the elbow 143 in the interior of the exhaust compartment 130 is curved. The contact-facing arm 141 is positioned so as to narrow the cross-sectional area of the exhaust compartment 130 where the exhaust chamber 131 and the exhaust channel 132 interface. The interface of the exhaust chamber 131 and the exhaust channel 132 is adjacent to the elbow 143. The channel 132 is bordered by the side wall 126 on one side and by the partition 124 (specifically the sidewall-facing arm 142) on the other side.

The side wall 126 comprises an exterior surface 127 that is planar and disposed on the exterior of the pole housing 120. The side wall 126 further comprises a plurality of interior surfaces disposed in the interior of the pole housing 120, the interior surfaces including a majority surface 128 and a lesser vent surface 129 (referred to as such because there is also a greater vent surface 146, discussed later herein). The majority surface 128 comprises the majority of the side wall surface area disposed inside of the pole housing 120. The majority surface 128 is planar and parallel to the exterior surface 127. In an exemplary embodiment, the majority surface 128 is orthogonal to the surface of the stationary contact 104 that faces the movable contact 106. The lesser vent surface 129 is adjacent to the majority surface 128 and to the exterior surface 127, and extends between the majority surface 128 and the exterior surface 127. The lesser vent surface 129 is non-orthogonal to both the majority surface and the exterior surface 127.

The sidewall-facing arm 142 of the partition 124 comprises two planar surfaces that face the side wall 126, a diverging surface 144 and a greater vent surface 146. A portion of the diverging surface 144 faces the majority surface 128, while another portion of the diverging surface 144 faces the lesser vent surface 129 and the exhaustion vent opening 133. The greater vent surface 146 is adjacent to the diverging surface 144 and to the top wall 125, and extends between the diverging surface 144 and the top wall 125. The greater vent surface 146 is non-orthogonal to both the diverging surface 144 and to the top wall 125.

A sidewall corner 151 (FIG. 3) is formed where the majority surface 128 and the lesser vent surface 129 meet, and a partition corner 152 (FIG. 3) is formed where the diverging surface 144 and the greater vent surface 146 meet. The exhaust channel 132 comprises a mouth 154, which is where the cross-sectional area of the exhaust channel 132 extends between the sidewall corner 151 and the partition-side corner 152. It is noted that the sidewall corner 151 and the partition corner 152 can instead be formed as rounded surfaces without departing from the scope of the disclosed concept. The exhaust channel 132 also comprises a throat 156, which is the narrowest part of the exhaust channel 132 (i.e. “narrowest” such that the cross-sectional area of the exhaust channel 132 is smallest at the throat 156). The throat 156 is located where the arc chamber 131 and the channel 132 interface, which is where the curved surface of the elbow 143 and the diverging surface 144 meet. The mouth 154 is positioned between the throat 156 and the exhaust vent opening 133, and the diverging surface 144 extends between the throat 156 and the mouth 154. The diverging surface 144 is disposed such that the cross-sectional area of the channel 132 increases when moving from the throat 156 toward the mouth 154. The portion of the channel 132 between the throat 156 and the mouth 154 is a diverging portion 157 (numbered in FIG. 3), and the portion of the channel 132 between the mouth 154 and the vent opening 133 is a venting portion 158 (numbered in FIG. 3). The cross-sectional area of the vent opening 133 is greater than or equal to the cross-sectional area of the mouth 154.

The exhaust channel 132 comprises a central axis 551 (FIG. 3), the central axis 551 extending along the length of the exhaust channel 132 and being disposed exactly halfway between the surfaces surrounding the exhaust channel 132. Because the exhaust vent opening 133 is positioned entirely laterally 512 relative to the throat 156 and relative to the mouth 154, the central axis 551 comprises a first line segment extending from the throat 156 to the mouth 154, and a second line segment extending from the mouth 154 to the exhaust vent opening 133, with the second line segment being disposed at an angle relative to the first line segment. The positioning of the throat 156 and the mouth 152 relative to the arc chamber 131 and relative to the exhaust vent opening 133 causes arcing gas entering into the exhaust channel 132 from the arc chamber 131 to first pass through the narrowest part of the channel 132 (i.e. the throat 156) before flowing toward wider parts of the channel 132 (i.e. toward the mouth 152). In contrast, in the prior art exhaust channel 16, the portion of the exhaust channel 16 adjacent to the arc chamber 15 is of a uniform width.

The exhaust compartment 130 additionally comprises a plurality of ribs 161A and 161B (which can be referred to generally as the “ribs 161”) that are not found in the prior art circuit breaker 1. Each rib 161 is a protrusion that extends into the exhaust channel 132 from one of the planar surfaces surrounding the exhaust channel 132. A plurality of ribs 161A are formed on and extend from the majority surface 128 into the arc chamber 131, and a plurality of ribs 161B are formed within the channel 132. In an exemplary embodiment, the arc chamber includes at least two ribs 161A and the channel 132 includes at least three ribs 161B. The individual ribs 161B are formed on opposite sides of the channel 132 in an alternating configuration such that, when traveling through the channel 132 from the throat 156 toward the exhaust vent opening 133, the first rib 161B is a single rib 161B formed on and extending from the diverging surface 144 into the channel 132, the second rib 161B is a single rib 161B formed on and extending from the majority surface 128 into the channel 132, and the third rib is a single rib 161B formed on and extending from the greater vent surface 146 into the channel 132. The second rib 161B is disposed upward 511 (i.e. closer to the top wall 125) relative to the first rib 161B, and the third rib 161B is disposed upward 511 (i.e. closer to the top wall 125) relative to the second rib 161B.

As shown in FIG. 3, each rib 161 comprises a base 162 and an outermost surface 163. The base 162 is coplanar with the planar surface from which the rib 161 extends, and the outermost surface 163 is the surface disposed opposite the base 162. It is noted that the distance each rib 161B extends into the channel 132 is short enough such that the outermost surface 163 of each rib 161B does not reach the channel's central axis 551.

The ribs 161A in the arc chamber 131 introduce turbulence into the exhaust channel 132, thus leading to more mixing of the arcing gas with the ambient air and faster cooling within the exhaust compartment 130. The ribs 161A alone do not cause any significant pressure reduction. The diverging nature of the exhaust channel 132 leads to greater reduction of pressure in the exhaust compartment 130 (relative to what the pressure would be if the exhaust channel 132 were primarily of a uniform width, as is the case in the prior art exhaust channel 16), and the ribs in the exhaust channel 132 elongate the flow path of arcing gas being exhausted, leading to additional cooling. It is noted that, although it is desirable to limit the extent to which the pressure and temperature of the arcing gas increase, the increased pressure and temperature enables the arcing gas to be exhausted more effectively than if the arcing gas were too stagnant.

The arc plate 170 shown in FIG. 4 can be included in the exhaust compartment 130 in order to expedite arc quenching. The arc plate 170 is produced from steel or another metal with similar electrical properties and is coupled to the side wall's majority surface 128 in a position as close as possible to the stationary conductor 103. In an exemplary embodiment, the surface of the arc plate 170 facing the interior of the arc chamber 131 is orthogonal to the surface of the stationary contact 104 that faces the movable contact 106. The arc plate 170 is positioned such that an arc can attach to/interact with the arc plate 170 and lose some heat to the arc plate 170, thus lowering the temperature of the gas exiting the arc chamber 131 and exiting the vent opening 133 even further. The specific arc plate 170 shown in FIG. 4 is intended to be illustrative in nature and is not intended to limit the geometry of any arc quenching device that can be included in the exhaust compartment 130. For example and without limitation, instead of the single plate design shown in FIG. 4, a wrap-around arc plate design can be used wherein the arc plate comprises two faces perpendicular to one another.

In addition to the advantages of the exhaust channel 132 already detailed herein, it is noted that the design of the exhaust channel 132 serves an important role in debris exhaust reduction/debris entrapment. During high overload and short circuit interruption test conditions, molten metal (droplets) from the separable contacts 104,106 can be created, which will cool down over time and solidify to form metallic particles. Tests indicate that these metallic particles (also called debris) exiting together with the hot exhaust gas can result in failures, by causing the ground fuse attached to the surrounding breaker enclosure 108 to blow. Hence, it is highly preferable to trap the debris and prevent its release through the exhaust vent opening 133. The debris, being heavier than the hot gas transporting it, will be unable to adjust quickly to the winding flow pattern created by the placement of the ribs 161 as described herein and shown in the figures. Hence, it is expected that the debris will impinge on/collide with the ribs 161 along the flow path, resulting in successful entrapment of the debris and thereby preventing release of the debris through the exhaust vent opening 133. Without the winding flow pathway created by the ribs 161 (especially the ribs 161B), the debris and the hot exhaust gases would flow right through the vent opening 133 without opposition and result in a test failure due to the ground fuse blowing.

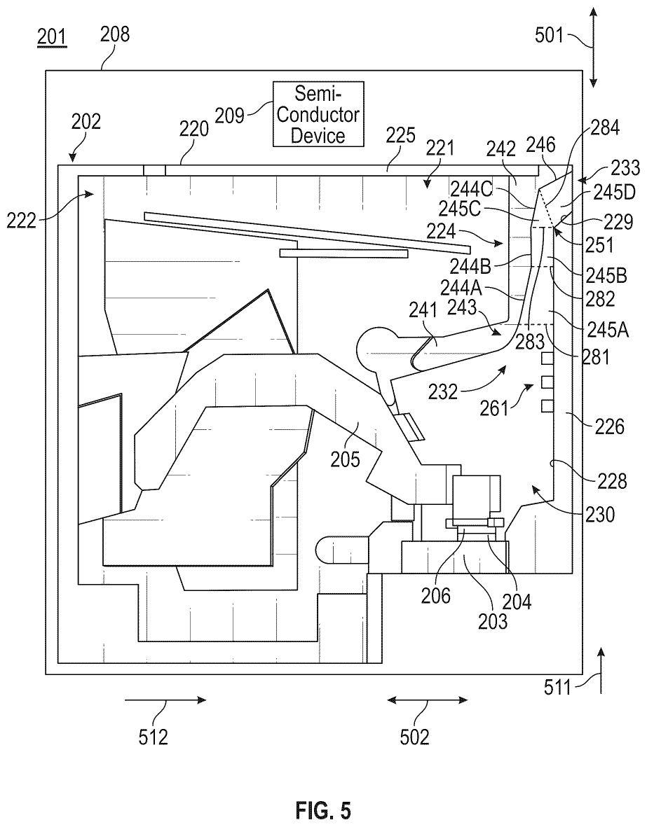

Reference is now made to FIG. 5, which is a sectional view of an improved circuit breaker 201, in accordance with another example embodiment of the disclosed concept. The improved circuit breaker 201 provides an improvement over the prior art circuit breaker 1 with respect to lessening the temperature and pressure increase caused by arcing gas, however, the circuit breaker 201 does not lessen the pressure and temperature increase to the same degree as the circuit breaker 101. The circuit breaker 201 comprises several components that are structurally and functionally equivalent to the components of the circuit breaker 101, and the components of the circuit breaker 201 are thus numbered with the same reference numbers used for the circuit breaker 101, incremented by 100. Although not shown in any figures, the circuit breaker 201 can also optionally include an arc plate 270 corresponding to the arc plate 170 shown included in the circuit breaker 101 in FIG. 4, and it should be understood that such an arc plate 270 would be coupled to the portion of the majority surface 228 corresponding to the portion of the majority surface 128 to which the arc plate 170 is coupled in FIG. 4. The primary difference between the circuit breaker 201 and the circuit breaker 101 is that the structure of the exhaust channel 232 of the circuit breaker 201 differs from the structure of the exhaust channel 132 of the circuit breaker 101. Because the shape of one side of the channel 232 is determined by the structure of the partition 224, it will be appreciated that the structure of the partition 224 also differs somewhat from the structure of the partition 124.

The partition 224 shares some general similarities with the partition 124. For example, the partition 224 comprises a contact-facing arm 241 and a sidewall-facing arm 242 that are continuous with one another and meet one another so as to form an elbow 243, and the surface of the elbow 243 in the interior of the exhaust compartment 230 is curved. However, where the partition 124 only comprises one planar surface (the diverging surface 144) aside from the greater vent surface 146 that faces the side wall 126, the partition 224 comprises more planar surfaces that face the side wall 226 aside from the greater vent surface 246. In particular, the partition 224 comprises three planar surfaces that collectively form the counterpart to the diverging surface 144 and face the side wall 226: a converging surface 244A, a throat surface 244B, and a diverging surface 244C. The channel 232 comprises a converging portion 245A that corresponds to the length of the converging surface 244A, a throat portion 245B that corresponds to the length of the throat surface 244B, and a diverging portion 245C that corresponds to the length of the diverging surface 244C.

The location where the arc chamber 231 and the channel 232 interface is the neck 281 of the channel 232, the neck 281 being the cross-sectional area where the curved surface of the elbow 243 and the planar converging surface 244A meet. The location where the converging portion 245A and the throat portion 245B meet is a first throat end 282 of the channel 232. The converging portion 245A is referred to as “converging” because its cross-sectional area is greatest at the neck 281 and continually decreases when moving from the neck 281 toward the first throat end 282. The location where the throat portion 245B and the diverging portion 245C meet is a second throat end 283. The throat portion 244B is the narrowest portion of the channel 232 and has a uniform cross-sectional area between the first throat end 282 and the second throat end 283, such that the throat portion 244B is where the cross-sectional area of the channel 232 is smallest. It is noted that the first throat end 282 and the second throat end 283 are referred to as “first” and “second” solely to distinguish the two throat ends 282,283 from one another, and the two throat ends 282,283 can instead be referred to as the “second throat end 282” and the “first throat end 283” as clarity necessitates.

The location where the diverging portion 245C meets the greater vent surface 246 is a mouth 284 of the channel 232. The diverging portion 245C is referred to as “diverging” because its cross-sectional area is smallest at the second throat end 283 and continually increases when moving from the second throat end 283 to the mouth 284. The portion of the channel 232 between the mouth 284 and the vent opening 233 is a venting portion 245D. The cross-sectional area of the vent opening 233 is greater than or equal to the cross-sectional area of the mouth 284. A sidewall corner 251 is formed where the majority surface 228 and the lesser vent surface 229 meet, and it is noted that the throat portion 244B, the diverging portion 245C, and the venting portion 245D meet at the sidewall corner 251. It is noted that the sidewall corner 251 can instead be formed as a rounded surface and that any other corners of the channel 232 can instead be formed as rounded surfaces without departing from the scope of the disclosed concept.

Similarly to the ribs 161A of the pole housing 120, the ribs 261 in the arc chamber 231 introduce turbulence into the exhaust channel 232, thus leading to more mixing of the arcing gas with the ambient air and faster cooling within the exhaust compartment 230. The ribs 261 alone do not cause any significant pressure reduction. However, the flow of the arcing gas entering the exhaust channel 232 first through the converging portion 245A, then through the throat portion 245B, then through the diverging portion 245B, and lastly through the venting portion 245C, significantly reduces the pressure of the arcing gas.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A pole housing structured to house a pole assembly of a circuit breaker, the pole housing comprising:
a main compartment formed within the interior of the pole housing;
an exhaust compartment formed within the interior of the pole housing, the exhaust compartment comprising:
an arc chamber structured to house separable contacts of the circuit breaker; and
an exhaust channel comprising a first end and a second end, the first end being a throat in fluid communication with the arc chamber, the second end being a vent opening that is in fluid communication with the environment external to the pole housing;
a partition structured to partially separate the main compartment and the exhaust compartment;
a first wall, the first wall being a top wall disposed at the top of the pole housing when the pole housing is positioned in a first orientation; and
a second wall, the second wall being adjacent to the first wall and being a side wall disposed at the side of the housing when the pole housing is positioned in the first orientation,
wherein the cross-sectional area of the exhaust channel is smallest at the throat,
wherein the exhaust channel comprises:
a mouth between the throat and the vent opening, the cross-sectional area of the exhaust channel being greater at the mouth than at the throat;
a diverging portion disposed between the throat and the mouth; and
a venting portion between the mouth and the vent opening,
wherein a central axis of the exhaust channel comprises a first line segment in the diverging portion and comprises a second line segment in the venting portion, the second line segment being disposed at an angle to the first line segment,
wherein the vent opening is an opening formed in the second wall, and when the pole housing is disposed in the first orientation, the vent opening is disposed laterally relative to the arc chamber, and
wherein the exhaust compartment comprises a plurality of ribs, each rib being a protrusion extending from a planar surface into the interior of the exhaust compartment.

2. The pole housing of claim 1,
wherein the diverging portion is structured such that the cross-sectional area of the exhaust channel continually increases when moving from the throat to the mouth.

3. The pole housing of claim 1,
wherein the cross-sectional area of the vent opening is greater than or equal to the cross-sectional area of the mouth.

4. The pole housing of claim 1,
wherein the pole housing is structured such that, when the pole housing is disposed in the first orientation:
a passage providing fluid communication between the main compartment and the exhaust compartment is disposed beneath the partition,
a majority surface of the side wall is disposed opposite the passage, the majority surface being planar,
a first group of ribs in the plurality of ribs are positioned on a majority surface of the side wall in the arc chamber.

5. The pole housing of claim 4,
wherein the partition comprises a diverging surface that faces and is non-orthogonal to the majority surface,
wherein the diverging surface extends between the throat and the mouth.

6. The pole housing of claim 5,
wherein the side wall comprises a lesser vent surface that extends between the majority surface and the vent opening, the lesser vent surface being non-orthogonal to the majority surface,
wherein the partition comprises a greater vent surface that extends between the diverging surface and the vent opening, the greater vent surface being non-orthogonal to the diverging surface.

7. The pole housing of claim 6,
wherein a second group of ribs in the plurality of ribs are positioned within the exhaust channel,
wherein the second group of ribs includes a first channel rib, a second channel rib, and a third channel rib,
wherein the first channel rib is positioned closest to the throat, the third channel rib is positioned closest to the vent opening, and the second channel rib is positioned between the first channel rib and the third channel rib.

8. The pole housing of claim 7,
wherein the pole housing is structured such that, when the pole housing is disposed in the first orientation:
the first channel rib is positioned on the diverging surface,
the second channel rib is positioned on the majority surface, and
the third channel rib is positioned on the greater vent surface.

9. A circuit breaker, the circuit breaker comprising:
a breaker enclosure;
a semiconductor device;
a stationary conductor comprising a stationary contact;
a movable conductor comprising a movable contact, the movable conductor being structured to be actuated between a closed state and an open state, the movable contact being in electrical contact with the stationary contact in the closed state and being electrically isolated from the stationary contact in the open state; and
a pole housing, the pole housing comprising:
a main compartment formed within the interior of the pole housing;
an exhaust compartment formed within the interior of the pole housing, the exhaust compartment comprising:
an arc chamber structured to house the stationary and movable separable contacts; and
an exhaust channel comprising a first end and a second end, the first end being a throat in fluid communication with the arc chamber, the second end being a vent opening that is in fluid communication with the environment external to the pole housing;
a partition structured to partially separate the main compartment and the exhaust compartment;
a first wall, the first wall being a top wall disposed at the top of the pole housing when the breaker enclosure is positioned in a first orientation; and
a second wall, the second wall being adjacent to the first wall and being a side wall disposed at the side of the housing when the breaker enclosure is positioned in the first orientation,
wherein the breaker enclosure houses the pole housing and the semiconductor device,
wherein, when the breaker enclosure is positioned in the first orientation, the semiconductor device is disposed above the pole housing,
wherein the cross-sectional area of the exhaust channel is smallest at the throat,
wherein the exhaust channel comprises:
a mouth between the throat and the vent opening, the cross-sectional area of the exhaust channel being greater at the mouth than at the throat;
a diverging portion disposed between the throat and the mouth; and
a venting portion between the mouth and the vent opening,
wherein a central axis of the exhaust channel comprises a first line segment in the diverging portion and comprises a second line segment in the venting portion, the second line segment being disposed at an angle to the first line segment,
wherein the vent opening is an opening formed in the second wall, and when the breaker enclosure is disposed in the first orientation, the vent opening is disposed laterally relative to the arc chamber, and
wherein the exhaust compartment comprises a plurality of ribs, each rib being a protrusion extending from a planar surface into the interior of the exhaust compartment.

10. The circuit breaker of claim 9,
wherein the diverging portion is structured such that the cross-sectional area of the exhaust channel continually increases when moving from the throat to the mouth.

11. The circuit breaker of claim 9,
wherein the cross-sectional area of the vent opening is greater than or equal to the cross-sectional area of the mouth.

12. The circuit breaker of claim 9,
wherein the pole housing is structured such that, when the breaker enclosure is disposed in the first orientation:
a passage providing fluid communication between the main compartment and the exhaust compartment is disposed beneath the partition,
a majority surface of the side wall is disposed opposite the passage, the majority surface being planar, and
a first group of ribs in the plurality of ribs are positioned on a majority surface of the side wall in the arc chamber.

13. The circuit breaker of claim 12,
wherein the partition comprises a diverging surface that faces and is non-orthogonal to the majority surface, and
wherein the diverging surface extends between the throat and the mouth.

14. The circuit breaker of claim 13,
wherein the side wall comprises a lesser vent surface that extends between the majority surface and the vent opening, the lesser vent surface being non-orthogonal to the majority surface,
wherein the partition comprises a greater vent surface that extends between the diverging surface and the vent opening, the greater vent surface being non-orthogonal to the diverging surface.

15. The circuit breaker of claim 14,
wherein a second group of ribs in the plurality of ribs are positioned within the exhaust channel,
wherein the second group of ribs includes a first channel rib, a second channel rib, and a third channel rib,
wherein the first channel rib is positioned closest to the throat, the third channel rib is positioned closest to the vent opening, and the second channel rib is positioned between the first channel rib and the third channel rib.

16. The circuit breaker of claim 15,
wherein the pole housing is structured such that, when the breaker enclosure is disposed in the first orientation:
the first channel rib is positioned on the diverging surface,
the second channel rib is positioned on the majority surface, and
the third channel rib is positioned on the greater vent surface.
